(19) United States
(12) Patent Application Publication
(10) Pub. No.: US 2015/0127668 A1
(43) Pub. Date: May 7, 2015

(54) DOCUMENT GENERATION SYSTEM

(71) Applicants: Denise TROTTIER, Montreal (CA); Gilles THIBAULT, Montreal (CA); Pierre-Olivier CHARLEBOIS, Ottawa (CA); Simon POISSANT, St-Hubert (CA)

(72) Inventors: Denise TROTTIER, Montreal (CA); Gilles THIBAULT, Montreal (CA); Pierre-Olivier CHARLEBOIS, Ottawa (CA); Simon POISSANT, St-Hubert (CA)

(21) Appl. No.: 14/072,557

(22) Filed: Nov. 5, 2013

Related U.S. Application Data
(60) Provisional application No. 61/899,614, filed on Nov. 4, 2013.

(51) Int. Cl. G06F 17/27

(52) U.S. Cl. CPC G06F 17/2705
USPC 707/755

(57) ABSTRACT

The invention describes a system and method for dynamically composing and generating documents, by breaking down text and multi-media content into small, independent content blocks and then re-ordering and recompiling them in different ways to create a plurality of different documents on demand. The system allows users to select a document type and then specify the desired parameters of the document. The invention employs a semantic network and an expert system to select the appropriate content blocks from a content repository, and then iteratively applies rules to ensure that the selected content is compatible and all dependencies are met. The system then renders the assembled document to the desired file format.

### CROSS REFERENCE TO RELATED APPLICATION

This application claims the benefit under 35 USC §119(e) of U.S. provisional patent application Ser. No. 61/899,614 filed on Nov. 4, 2013. The contents of the above-mentioned patent application are incorporated herein by reference.

### FIELD OF THE INVENTION

The present invention relates to computer implemented methods for generating one or more documents based on processing a plurality of text units. The invention also extends to devices and components thereof for performing the methods.

### BACKGROUND

Document generation and management systems are computer systems which are based on a web server architecture but can be any computing device that generates and stores documents. There are many different types of document generation and management systems on the market that provide different services. For example, there are many websites that offer document generation and management services.

A popular type of document generation and management websites are website that offer the generation of legal documents. A user will interact with a document generation and management website in order to create a specific legal document or a group of related legal documents. The types of documents that these websites can generate vary from wills, different types of contracts, to documents associated with creating a call for tenders, among others.

The general drawback of currently available document generation and management systems are that most use template based methods. These template methods usually involve a simple document which is previously created in a template format and a user modifies the template or responds to questions which then modify the template for the user. This process of generating documents based on a template can be inefficient and ineffective for certain individuals generating certain types of documents. This can especially be inefficient when a user generates multiple related documents as the user has to update the template for each document.

An object of the invention is to provide a document generation and management system that is more user friendly and can generate documents that are better tailored to the user's needs.

### BRIEF DESCRIPTION OF THE DRAWINGS

FIG. 1 is a block diagram of a document generation and management system in accordance with a specific and non-limiting example of implementation of the invention.

FIG. 2 is a block diagram of the document generation and management system in accordance illustrating various components of the document generation and management system and of a computing entity.

FIG. 3 is a flowchart that illustrates step in the process of a user at a computing entity connects and communicates with the document generation and management system in order to generate a document or document set of related documents.

FIG. 4 illustrates a graphical use interface on a computing entity illustrating a web browser viewing the document generation and management system at the step of a user login on.

FIG. 5 illustrates a graphical use interface on a computing entity illustrating a web browser viewing the document generation and management system at the step of a user selecting a “Call of Tender” document set type that the user wants generated.

FIG. 6 illustrates a graphical use interface on a computing entity illustrating a web browser viewing the document generation and management system at the step of a user entering in general information for “Call of Tender” document set type to be generated.

FIGS. 7 and 8 illustrates a graphical use interface on a computing entity illustrating a web browser viewing the document generation and management system at the step of a user entering selecting the filters to be applied for “Call of Tender” document set type to be generated.

FIG. 9 illustrates a table in a database on the document generation and management system showing the storing a plurality of text units.

FIG. 10 is a flowchart illustrating the process or step applied in document generation and management system to each of the text units in the database in order to obtain text units to be parsed in to sets.

FIG. 11 illustrates a simple non-limiting example of a set of text units sorted according to the flow chart illustrated in FIG. 12.

FIG. 12 is a flowchart that sets out the process or step applied in document generation and management system to sorting obtained text units.

FIG. 13 is a flowchart illustrating the process or steps applied in document generation and management system for the execution of the three rules of dependency, incompatibility and complimentary applied to obtained text units.

FIG. 14 illustrates a graphical use interface on a computing entity illustrating a web browser viewing the document generation and management system at the Information and Instruction panel and at the step of a user seeing sorted obtained text units where user interaction is required or where user interaction is available.

FIG. 15 illustrates a section of what is seen by the user on his or her graphical use interface when viewing the Information and Instruction panel when the user has the option to select one of the two mandatory clauses.

FIG. 15b illustrates a flowchart of the steps or process executed by the central processing unit or CPU in one embodiment of the document generation and management system.

FIG. 16 illustrates a section of what is seen by the user on his or her graphical use interface when viewing the Information and Instruction panel when the user has is shown clause that cannot be selected because it is disabled.

FIG. 17 illustrates a section of what is seen by the user on his or her graphical use interface when viewing the Information and Instruction panel where the user can deselect a clause.

FIG. 18 illustrates a section of what is seen by the user on his or her graphical use interface when viewing the Information and Instruction panel where the user has deselected the clause shown in FIG. 17.

FIG. 19 is a block diagram that illustrates the different data entities that are used to generate a document, and how they are organized within the system.

FIG. 20 is a block diagram that illustrates the functional components within the system.

FIG. 21 is a flow chart that illustrates each of the steps in the method disclosed for generating a document.

FIG. 22 is diagram illustrating the relationship between content blocks that are dependent content block and content blocks that are incompatible content blocks.

### DETAILED DESCRIPTION

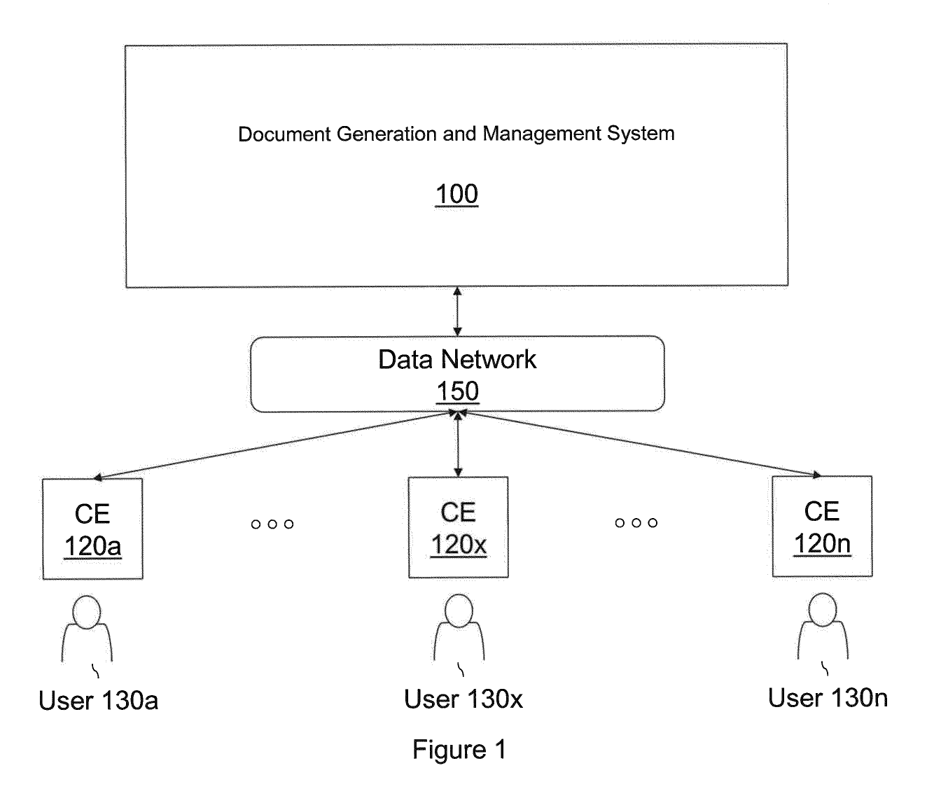

FIG. 1 is a block diagram of a document generation and management system (DGMS) 100 according to a non-limiting example of the implementation of the invention. The DGMS 100 can be a server, one or more stand-alone computers or any other generally portable or non-portable computing device that can communicate (wired or wirelessly) with one or more computing entities (CE) 120 (120a . . . 120x . . . 120n) over a data network 150. The CE 120 can be one or more stand-alone computers, servers, or any other generally portable or non-portable computing device that can communicate (wired or wirelessly) with the DGMS 100 over a data network 150. Users 130 (130a . . . 130x . . . 130n) interact with the CE 120 (120a . . . 120x . . . 120n) in order to communicate with the DGMS 100.

The data network 150 may be the internet, such that the DGMS 100 and the CE 120 communicate with each other over the internet. Other types of implementations of the connection between the DGMS 100 and the CE 120 exist without departing from the spirit of the invention, for instance, the data network 150 is a wide area network (WAN) or local area network (LAN) (i.e., the DGMS 100 and the CE 120 are part of the same data network); the CE 120 connect to a server as part of their own network (e.g., WAN or LAN) and then the server connects to the DGMS 100 over the data network 150; the data network 150 may comprise one or more data networks; or any other suitable network structure. Alternatively, the user 130 interacts with the DGMS 100 directly and no connection over a data network 150 is required for a user 130 to interact with the DGMS 100.

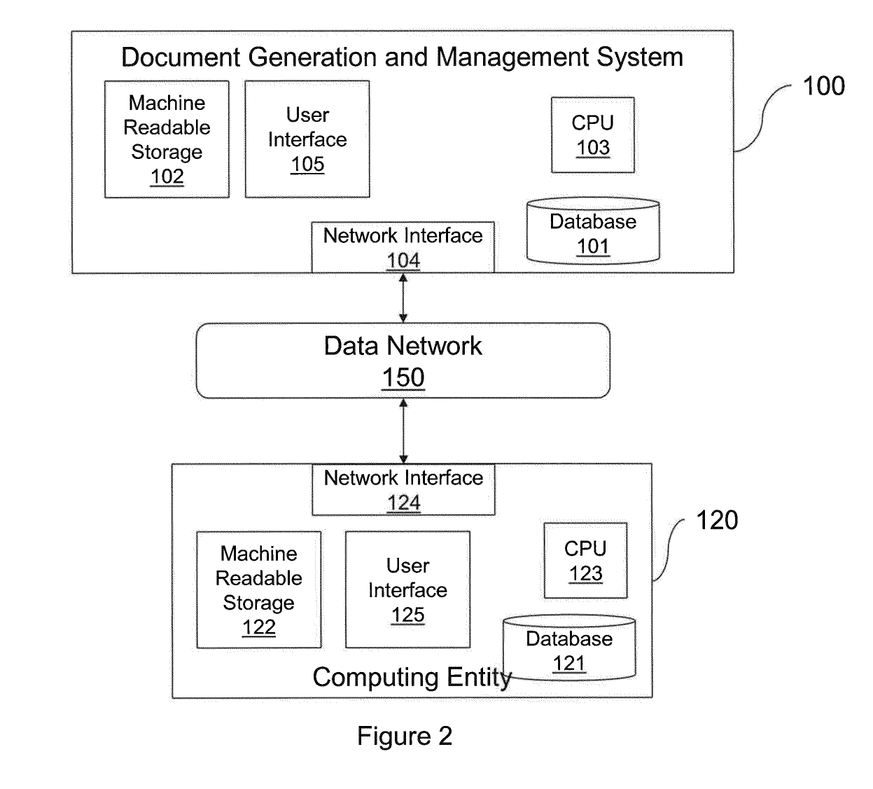

FIG. 2 is a more detailed block diagram of the DGMS 100 showing the key hardware elements of the DGMS. The DGMS 100, which in this particular case is a server 100, may have, inter alia, a central processing unit or CPU 103, machine readable storage 102, a database 101, a network interface 104 and a user interface 105. Note that this list is not exhaustive and the DGMS 100 may include additional components. The CPU 103, machine readable storage 102, the database 101, the network interface 104 and the user interface 105 may communicate with one another over one or more data buses. The DGMS 100 may also be running an operating system.

The machine-readable storage 102 can take various forms without departing from the spirit of the invention and it is designed to store program code for execution by the CPU 103. Typically, the machine-readable storage 102 is designed to retain data in a permanent fashion such that when power is turned off, the data will not be lost.

The database 101 can take various forms without departing from the spirit of the invention and it is designed to store data which may be retrieved by the CPU 103 as part of the execution of the stored program code. Similarly, the data may be stored in the database 101 by the CPU 103 as part of the execution of the stored program code. Typically, the database 101 is designed to retain data in a permanent fashion such that when power is turned off, the data will not be lost. Furthermore, the database 101 may comprise one or more databases.

The network interface 104 can take various forms without departing from the spirit of the invention and it is used to connect to the data network 150 to communicate with the one or more CE 120.

The user interface 105 can take various forms without departing from the spirit of the invention and it may be a graphical user interface (GUI) that allows a user to interact with the DGMS 100. Without the intention of being bound by a specific definition, a GUI would typically include means to deliver visually information to the user, such as a display, and also graphical tools allowing the user to make selections and input commands. The user's selections and input commands may then be directed to the one or more data bus such that those signals can be processed by the CPU 103.

FIG. 2 also illustrates a detailed block diagram of the CE 120. The CE 120, which in this particular case is a computer 120, may have, inter alia, a CPU 123, machine readable storage 122, a database 121, a network interface 124 and a user interface 125. Note that this list is not exhaustive and the CE 120 may include additional components. The CPU 123, machine readable storage 122, the database 121 the network interface 124 and the user interface 125 can then communicate with one another over one or more data buses. The CE 120 may also be running an operating system.

The CPU 123, machine readable storage 122, the database 121, the network interface 124 and the user interface 125 can take various forms without departing from the spirit of the invention and may function in a similar manner as the CPU 103, machine readable storage 102, the database 101, the network interface 104 and the user interface 105, respectively and as discussed above.

The user interface 125 can take various forms without departing from the spirit of the invention and it may be a GUI that allows a user to interact with the CE 120 in order to communicate and interact with the DGMS 100. The GUI may be visible on a screen or monitor connected to or part of the CE 120. The user 130 may interact with the GUI with a keyboard and/or mouse, or any other suitable device. The screen or monitor may have touch sensibilities and the user 130 may interact with the GUI using touch gestures. The user's selections and input commands through the GUI may then be directed to the one or more data bus such that those signals can be processed by the CPU 123.

In a specific and non-limiting example the DGMS 100 is a server connected to the internet via the network interface 104. The DGMS 100 is a web server that is running web server software (such as Apache, IIS, nginx, GWS, etc.) which may be part of the execution by the CPU 103 of the stored program code in the machine readable storage 102. The DGMS 100 is a web server whose function is to deliver web pages using Hyper Text Transfer Protocol (HTTP) to a web browser. The webpage delivered may be HTML documents, which may include images, videos, style sheets and scripts in addition to text content. The HTML documents may be dynamically created based on users requests by a server-side scripting language (such as PHP, Ruby on Rails, ASP, ASP.Net, Perl, etc.). The HTML documents delivered may also contain client-side scripting language in order to have different and changing content depending on user input without making requests back to the web server to generate a new web page (such as Java Script, jQuery, etc). The DGMS 100 web server has an uniform resource locator (URL) also known as web address, host name or domain name that can be entered into a web browser in order to communicate with the web server.

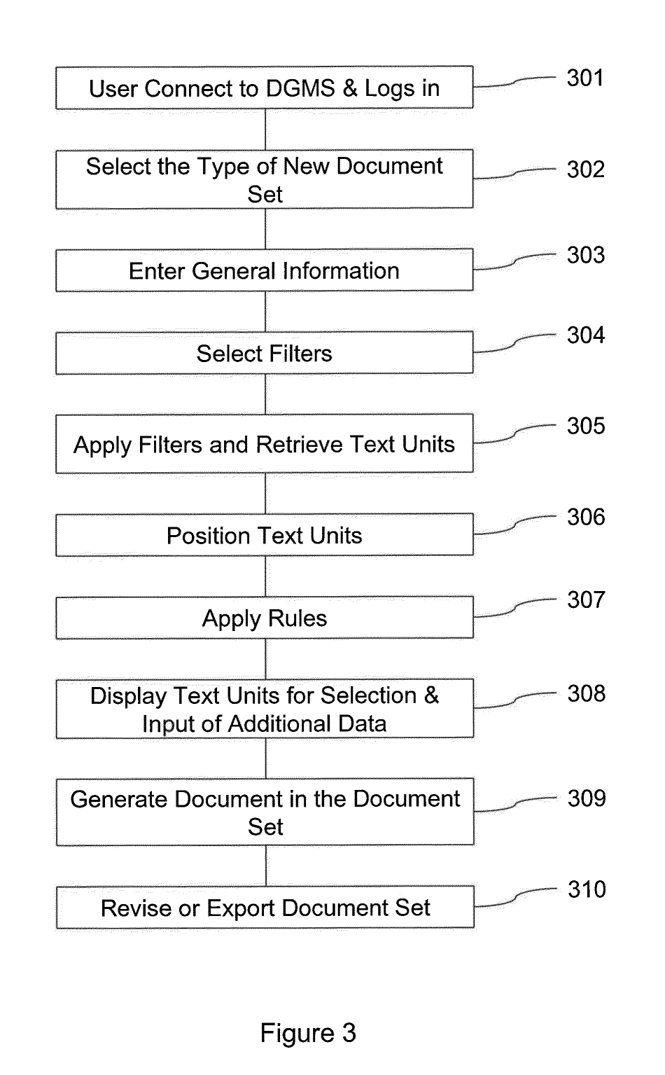

FIG. 3 is a flowchart which illustrates the main steps, in this example, that are performed when a user 130 at CE 120 connects and communicate with the DGMS 130 in order to generate a document or document set of related documents. The user 130 is a user that is interested in generating a document or a set of related documents. The user 130 at CE 120, in this example, interacting with the GUI to connect to the DGMS using a web browser (such as Internet Explore, Firefox, Google Chrome, etc) by typing in a specific URL in to the web browsers URL text box (step 301). The communication between the user's web browser and the web server may be a secure connection (such as Secure Sockets Layer (SSL), etc). The specific URL is the URL of the DGMS, as discussed above. The user 130 is prompted for credentials, which may be a user name and password (step 301).

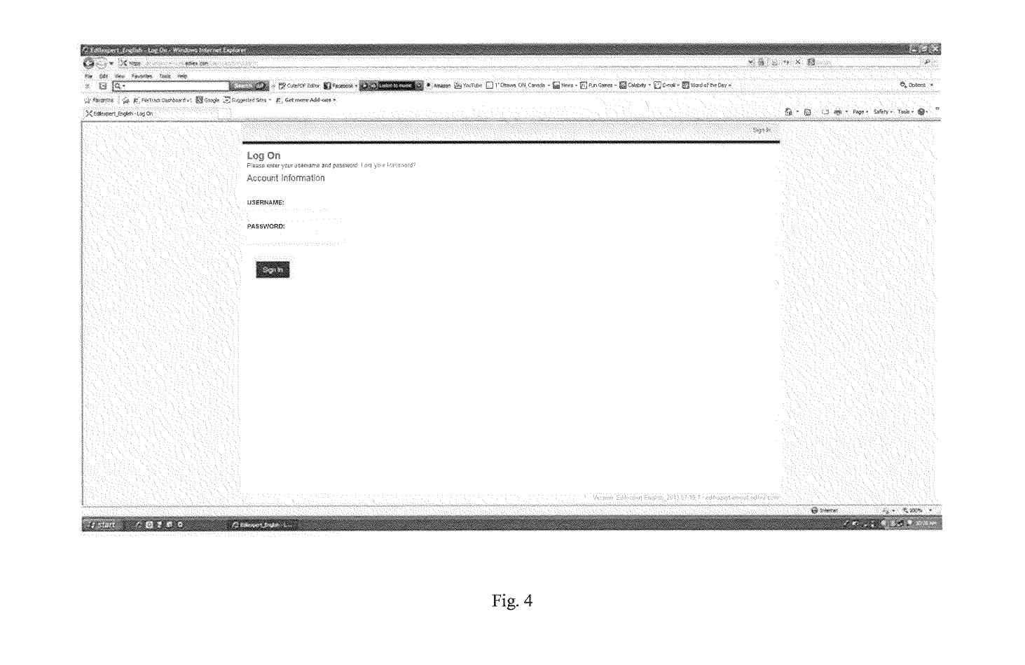

In a specific and non-limiting example the user is responsible for creating request for proposals (RFP) and such a process of creating the request for proposals by a user and a DGMS is illustrated in FIGS. 4-8 and 14-18.

FIG. 4 illustrates a specific example of a user interface that is displayed to the user when the user logs onto the DGMS 130, where the user is prompted to input his or her username and password. After the user enters in his or her credentials into the web browser and clicks or selects the “Sign In” button, the credentials are communicated to the web server. The CPU 103 as part of the execution of the stored program code may interact with the database 101 to determine if the user's credentials are correct. For instance, a user's table in the database 101 may store a list of users, their passwords (which may be stored in an encrypted format using standard encryption such as MD5 and use standard encryption techniques such as hashing and salt, etc.) and the user's level (such as, regular user, super user, or admin user).

Upon a successful validation of the user's credentials, the web server will communicate certain web pages to the user's 130 web browser. The user 130 is then able to interact or communicate with the DGMS 100 through the web browser present on the GUI to generate a document set, which may be one or more documents. It would be clear to a person skilled in the art that the actions by the user 130 such as clicking or selecting a certain button on the web page visible in the GUI may send requests from the user's 130 web browser to the web server which causes the CPU 103 to execute part of the stored program code to interact with the database 101 to either store or retrieve data, and to also generate web pages to be transmitted back from the web server to user's 130 web browser. The user 130 then selects the type of document set, which may be a single document or more than one document (step 302). The selection by the user 130 of the document set type in this example occurs by the user selecting or clicking on a button that indicates the document set type, but other methods of selecting the document set type such as selecting from a drop down menu or selecting from a form selection box, etc, may be possible without departing from the spirit of the invention.

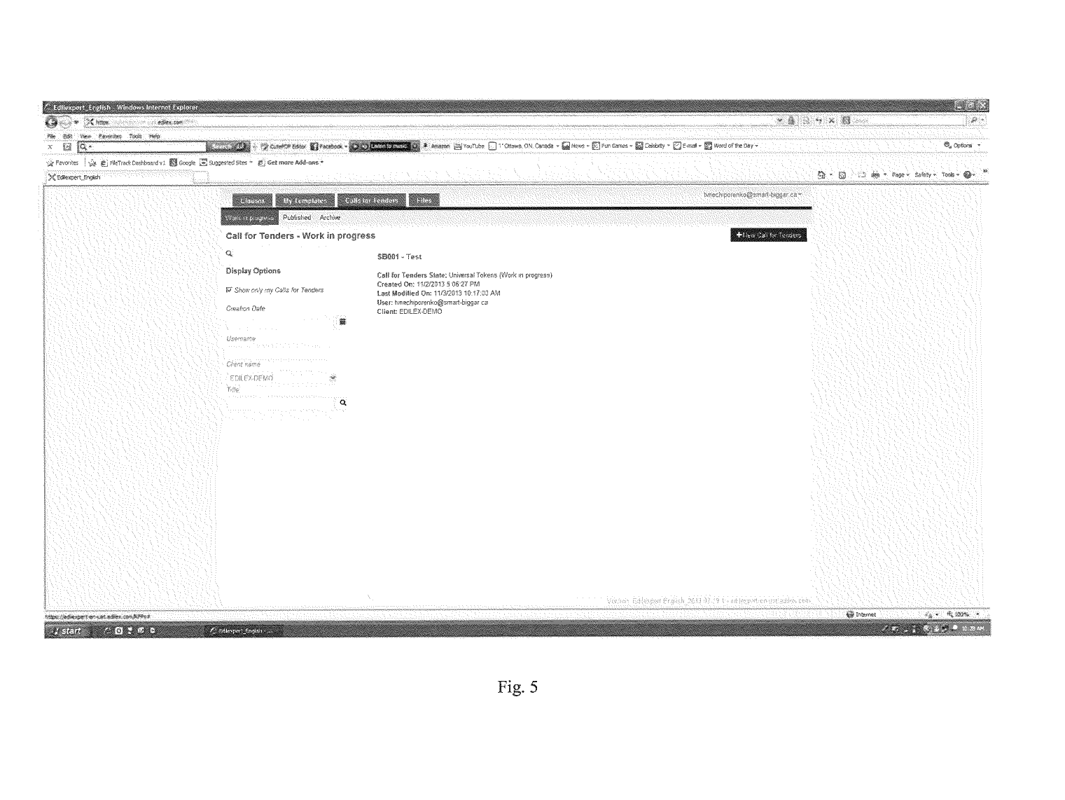

Continuing with the example above, in FIG. 5 the user 130 selects or clicks the button “New Call for Tenders” to generate a document set that can be used to obtain offers or bids from different bidders looking to obtain an award of business activity in the supply of work, supplies, or service contracts, etc. For example, a call for tenders document set may comprise three types of documents: (i) a first contract for the relationship with the requesting party (may be a public body) and bidders; (ii) a second contract for the relationship with the entity that wins the request for proposal; and (iii) a bid form that the entities can use to bid on the request for proposal. Although FIG. 5 illustrates a user generating a call for tenders or request for proposal document set, the present invention is not limited to such a document set. Other types of document sets may be: an employment contract and a stock option plan; articles of incorporation and a shareholders agreement, a board resolution and a financial contract; or any stand alone document, such as, a sales agreement, a will, or any other contract or legal or non-legal document. Note that this aforementioned list of documents sets is not exhaustive and there may be tens of thousands of different documents and document sets that this invention could generate.

It is worth pointing out that, in this example, step 302 only determines the document set type that will be later generated in step 307. That being said, the DGMS at step 302 may store in the database 101 the user's selection of the document set type. For instance, there may be a user's document sets table that stores for each the client's identification along with which type of documents set that the user is wishing to create, and other user selection data discussed below.

On the web browser visible in the GUI, the user 130 will then be prompted to enter in basic or general information such as file number, file name, a date associated with the file, etc (step 303). The general information that the user 130 is prompted to enter will depend on the document set type selected. That is, when the user selected the document set type at step 302, the CPU 103 may make a request to the database 101 and/or get instructions from the program code stored in the machine readable storage to get the type of information that will be prompted to the user 130.

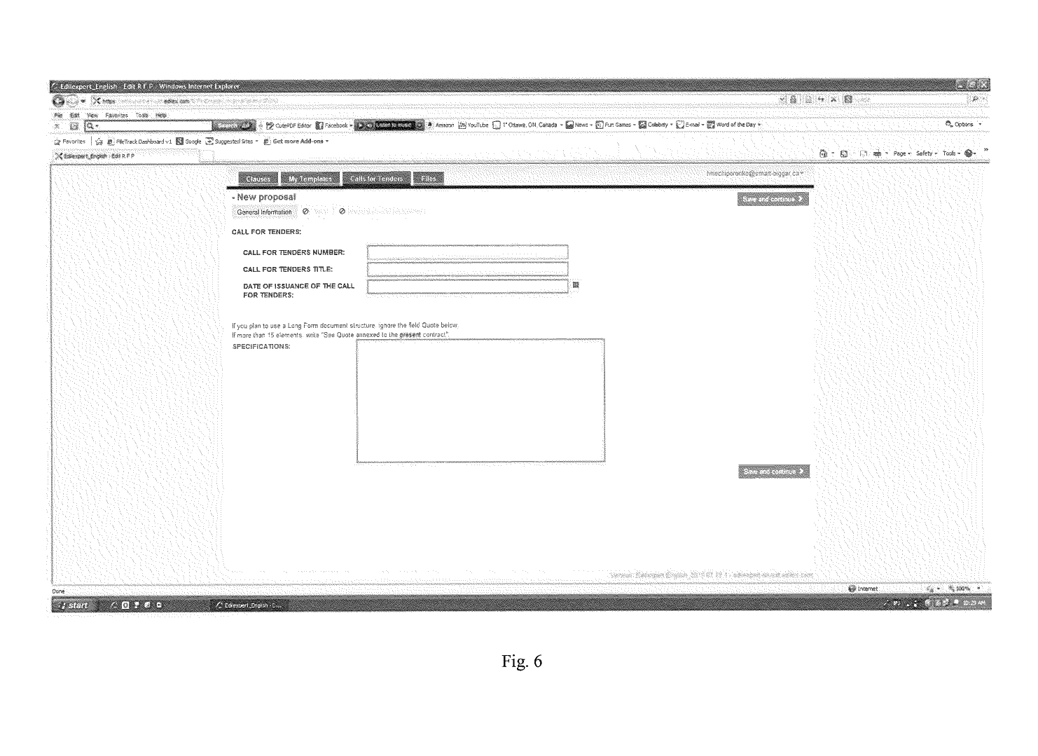

FIG. 6 illustrates a new proposal for a call for tenders where the user 130 can enter in general information such as a call for tenders number, call for tenders title, date of issuance of the call for tenders, and any specifications. After the user 130 enters in the general information, the user 130 can then select or click on “save and continue” to progress to the next step. Certain actions by the user 130 such as clicking or selecting a save button “Save and continue” will send requests to the web server while other actions by the user 130 such as clicking or selecting radio buttons may not send a request to the web server until the user clicks or selection a save button “Save and Continue”.

Alternatively, in another embodiment the step 303 of entering general information is part of the next step 304 the filtering of the document set options, and in other words the entering of the general information is not a separate step.

The user 130 is then presented with the filters panel visible on the web browser on the GUI (step 304). The filters panel presents the user 130 with the ability to select or filter several document set options to create a filtered document set options to be sent back to the DGMS 100. Furthermore, these document set options are specific to the type of document set type selected by the user 130 at step 302. The document set options can be presented to the user 130 in a number of different ways. For example, when the user clicked or selected the “Save and continue” button in FIG. 6, these document set options were obtained from the database 101 and/or generated from the executed instructions of the program code stored in the machine readable storage 102. Alternatively, these document set options were previously obtained from the database 101 and/or generated from the executed instructions of the program code stored in the machine readable storage as discussed above when the user 130 selected or clicked on the type of document set that the user 130 wanted to generate. For example, in FIG. 5 when the user selected or clicked the button “New Call for Tenders” the document set options may have alternatively been obtained at this time.

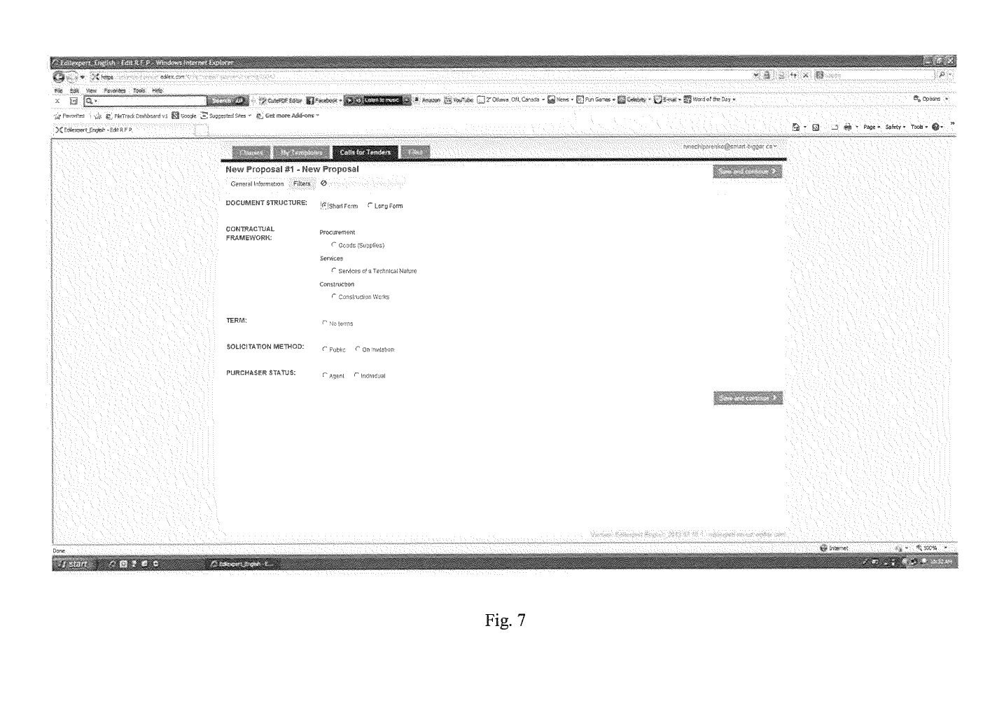

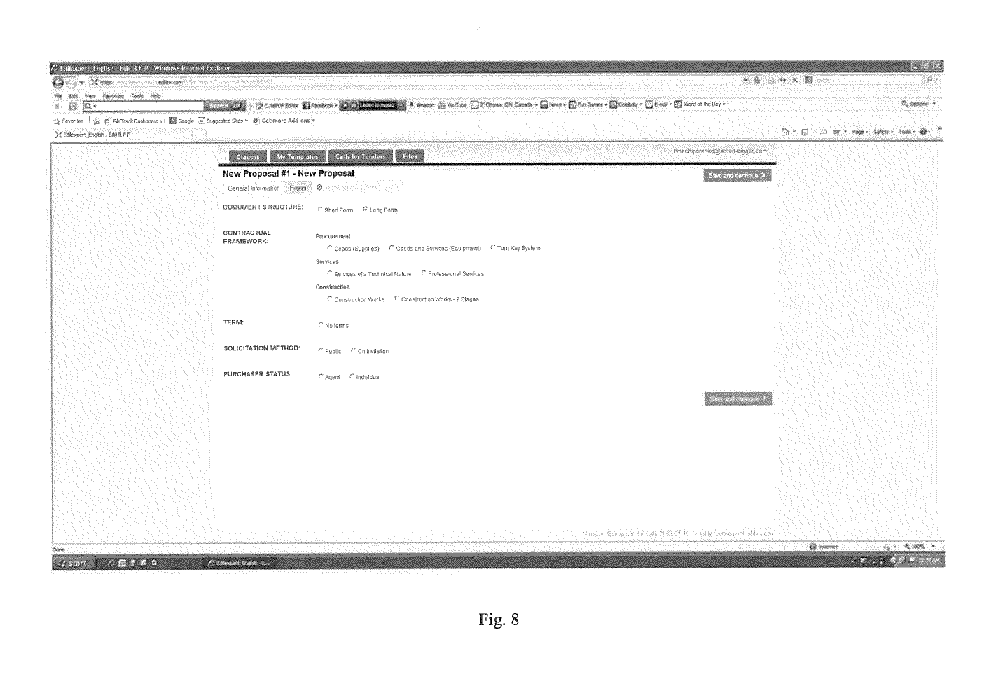

FIGS. 7 and 8, both of which illustrate an example of the filter panel as seen on the user's 130 GUI which shows the document set options which will be discussed in more detail below. The document set options visible on the user's 130 GUI relate to the type of document set being created. In this example, the user 130 is creating a call for tenders or request for proposals document set type and the document set options are options that would be specific at the preliminarily steps of creating a document set of this type. For instance, the document structure is a selection of radio buttons to select a short form or long form document structure depending on the type of contractual frame work the user 130 wants. As illustrated in FIG. 7, when the user 130 selects “Short Form” less or different options are visible or presented to the user 130 than when the user 130 selects “Long Form” as illustrated in FIG. 8.

Continuing to discuss FIGS. 7 and 8, the user 130 is given the option to also select the options relating to the contractual framework which include procurement, services and construction. For instance, when the Long Form document structure is selected the user 130 can select for procurement the options of: Goods (Supplies), Goods and Services (Equipment), or Turn Key system; for Services the options of: Services of a Technical Nature or Professional Services; and for Construction the options of: Construction Works or Construction Works—2 Stages. Furthermore, the user 130 can also select if the term is No term, whether the Solicitation Method is Public or On Invitation; and whether the Purchaser Status is an Agent or Individual. Once the user 130 is finished with selecting the different options the user 130 can then click or select “Save and continue” which then sends or communicates the filtered document set options to the DGMS 100.

Although FIGS. 7 and 8 illustrate the selection or filtering of the document set options being the selection of radio buttons, any other type of selection method such as check boxes, drops down menus or forms would be possible without taking away from the spirit of the invention.

The selection of the radio buttons or in other words the filtering of the document set options to create the filtered document set options (which may be referred to as one of more indicators) is an advantageous aspect to the present embodiment of the invention. This is because the filtered document set options are used by the DGMS 100 to determine which text units 900 the DGMS 100 needs to obtain from the database 101, which will be discussed in more detail below. By way of example, if the user 130 in FIG. 8 selects “Public” as the solicitation method this would result in the DGMS 100 obtaining or receiving at least some different text units 900 than if the user 130 had selected “On invitation”. Similarly, the user 130 in FIG. 8 if selects “Agent” this would result in the DGMS obtaining or receiving at least some different text units 900 than if the user had selected “Individual”. This is similar for all of the different options or radio buttons that the user 130 may choose or select from.

Although the document set options are discussed above in the context of creating a call for tenders or request for proposals document set, for each of the different type of documents that the DGMS 100 can generate each of these documents has its own document set options. For example, an employment contract and a stock option plan document set would have different document set options than a call for tenders document set, both of which have different document set options than a board resolution and a financial contract document set, etc.

Regardless of the type of document set being creating, an interesting aspect of this embodiment of the invention is that document set options are presented to the user 130 which selects different options to create filtered document set options that is communicated to the DGMS 100 in order to then select one or more text units 900.

Alternatively, in another embodiment the filter panel and the selection of the document set options is absent, and upon the user 130 selecting the document set type the document set type is communicated to the DGMS 100 in order for the DGMS 100 to then select one or more text units 900.

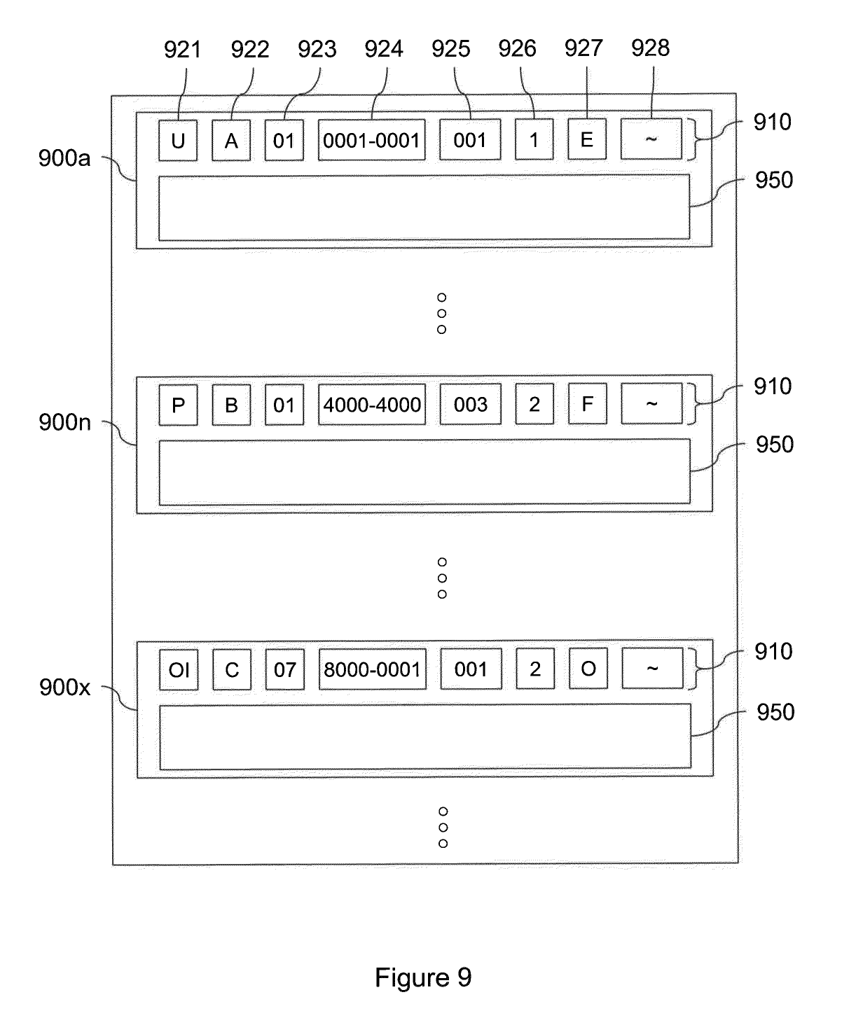

FIG. 9 illustrates the database 101 which contains one or more tables 960 for storing a plurality of text units 900 (900a . . . 900n . . . 900x) which may be retrieved from the database 101 by the CPU 103 upon the execution of the stored program code in the machine readable storage 102. Each of the text units 900 has a text element 950 that comprises text that may be selected or used to create the documents in the document set. For example, the text in the text unit 900 may be text relating to a clause in a legal agreement or contract. Alternatively, the text in the text unit can be any kind of text that may be used in any kind of document.

Each text unit 900 has a tag 910 which comprises one or more cells which may be referred to as cells, tag elements, cell indicators, or indicators. In a specific and non-limiting example, the text units 900 may have the following cells:
Situation Cell 921: The Situation Cell 921 may indicates whether the text unit can be universally applied across a document or if it only applies to a particular situation;
Document Type Cell 922: The Document Type Cell 922 may indicate which document in a document set the text unit applies to;
Section Cell or Contractual Cell 923: The Section Cell or Contractual Cell 923 may indicate the section of the document that the text unit belongs in. The Section Cell or Contractual Cell 923 may be a number used to indicate a section or position of the document that the text unit belongs in;
Text Unit ID Cell or Clause ID Cell 924: The Text Unit ID Cell or Clause ID Cell 924 may be an identification number for each of the text units. Text Unit ID Cell or Clause ID Cell 924 may be an arbitrarily assigned number or an automatically generate number, it may also be unique for each of the text units;
Version Number Cell 925: The Version Number Cell 925 may indicate the version number of the text unit. For example, the Version Number Cell 925 may auto increment when a previously saved text unit is modified;
Rank Cell 926: The Rank Cell 926 may indicate the rank or position of the text unit relative to other text units. The Rank Cell 926 may be related with the Section Cell or Contractual Cell 923 as the rank or position of the text unit may be relative to other text units within the same section of the document;
Pertinence Level Cell 927: The Pertinence Level Cell 927 may indicate whether the text unit is essential, important or optional for a specific document. For instance, essential text units may not be editable by a user as they are necessary or vital to the document; important text units may not be necessary or vital to a specific document but may be highly recommended to be included; optional text units may be of minor significance to the document and are completely optional to the user;
Note Cell 928: The Note Cell 928 may be used to include other notes or comments related to the text unit;

As noted above, the filtered document set options are used by the DGMS 100 to obtain one or more text units 900. Specifically in this example, upon receipt of the filtered document set options, the CPU 103 of the DGMS 100 then executes part of the stored program code in the machine readable storage 102 in order to determine which text units should be obtained or retrieved from the database 101 (step 305).

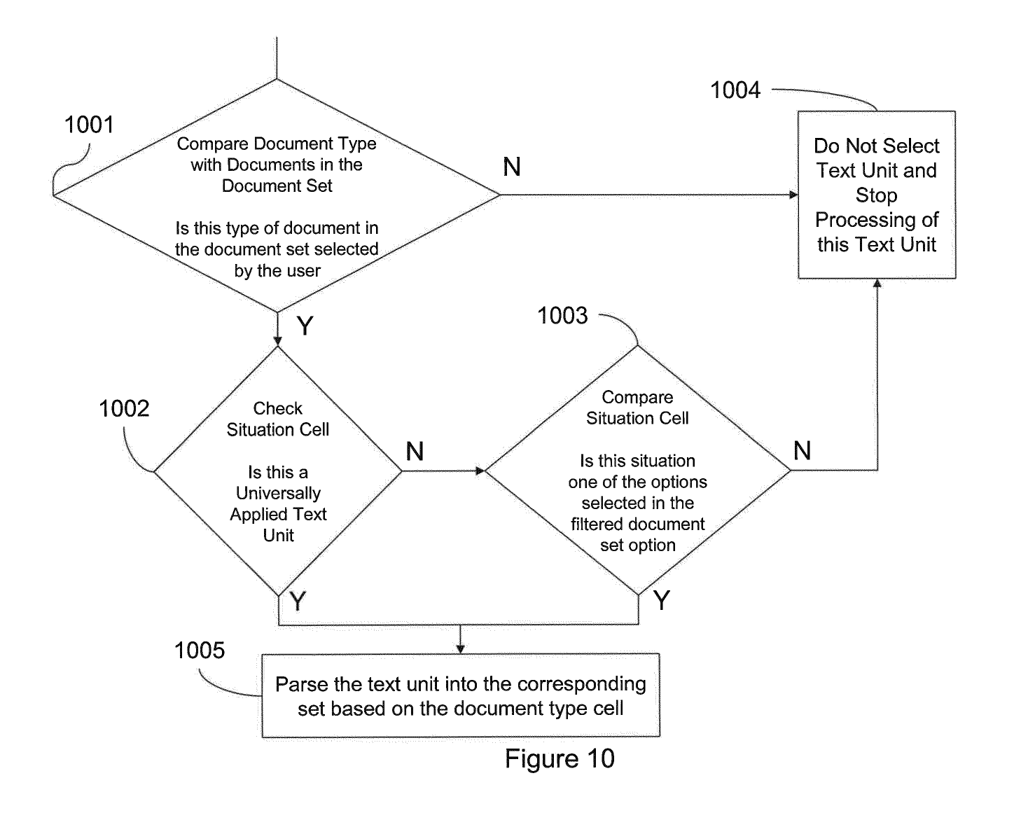

In this non-limiting example, part of the stored program code in the machine readable storage 102 is executed by the CPU 103 to traverse or query every text units 900a . . . 900n . . . 900x in the text unit table 960 of the database 101 and executes instructions to determine whether a text unit 900 should be obtained and parse into the document sets (or sets). FIG. 10 is a flowchart illustrating the instruction applied to each of the text units 900a . . . 900n . . . 900x in the text unit table 960 of the database 101. The following instructions are executed to determine whether a text unit 900a . . . 900n . . . 900x as illustrated in FIG. 9 should be selected. By way of example, the steps of FIG. 10 will be discussed where in this example a user 130 has selected a call for tenders document set type and has selected “Public” as the solicitation method, among other options selected in the filtered document set options. As discussed above, in the case for a call for tenders there are three documents that are required to be generated, for this example, the first contract is denoted “A”, the second contract is denoted “B”, and bid form is denoted “C”. Referring now to FIG. 10 with reference to FIG. 9, for the first text unit 900a at step 1001 the executed instructions or process check the Document Type Cell 922 which indicates document “A” and is one of the document types in the call for tenders document set, as such the instructions continue to process this text unit. Then the Situation Cell 921 is read to determine if it is an universally applied text unit or not (step 1002). By way of example, in this case the Cell 921 has a “U” that indicates that it is universally applied and that it should be included in text unit parsed into the sets. The text unit 900a is then parsed in to the set that corresponds with document “A” as such it is indicated in the Document Type Cell 922 (step 1005). For the next text unit 900n at step 1001 the executed instructions or process check the Document Type Cell 922 which indicates document “B” which is one of the document types in call for tenders document set, as such the executed instructions continue to process this text unit. Then the Situation Cell 921 is read to determine if it is an universally applied text unit or not (step 1002). In this case, Situation Cell 921 has an indicator that reads “P” which indicates that it is a clause that applies to a “Public” solicitation method. Step 1003 is then applied in this case and compares the Situation Cell 921 indicator with the options selected in the filtered document set options. As noted above for this example the user 130 has selected the “Public” solicitation method and as the Situation Cell 921 indicates that this text unit applies for the “Public” solicitation method, this text unit 900n can be included in text unit parsed into the sets. At step 1005 the text unit 900n is then parsed in to the set that corresponds with document “B” based on its indicator in the Document Type Cell 922. Similarly, at step 1001 text unit 900x is determined to correspond with document “C” and processing of the text unit continues. At step 1002 the Situation Cell 921 as it was done previously for the other text units is read, however, here the Situation Cell 921 has an indicator that reads “OI” which indicates that it is a text unit that applies to a “On Invitation” solicitation method. As in this example, the user 130 selected “Public” solicitation method, the text unit 900x cannot be included in text unit parsed into the sets and, as such, processing of the text unit 900x stops here. The three examples given above are for illustrative purposes only. The processing of the text units 900 would take place on a plurality of text units which may includes tens of thousands and possibility hundreds of thousands of text units. Furthermore, note that different nomenclature or values may be used for the tags, the cells of the tags, and indicators in the cells illustrated above without taking away from the spirit of the invention.

In the example given above each of these selected one or more text units are arranged or parsed into one of a plurality of sets. Alternatively, each of these selected one or more text units may be arranged or parsed in to one or more sets, where each set relates or corresponds to a document in the document set. In other words, it is possible for a text unit to be included in more than one of the documents in the document set and could even be included in all of the documents of the document set. This can easily be done by having an indicator in the Document Type Cell 922 that indicates that this clause could apply to multiple documents and which of the multiple documents it applies to. In another alternative the obtained text units are not parsed into sets at step 1005 but are parsed into sets a later process step or time when the documents in the document sets are generated.

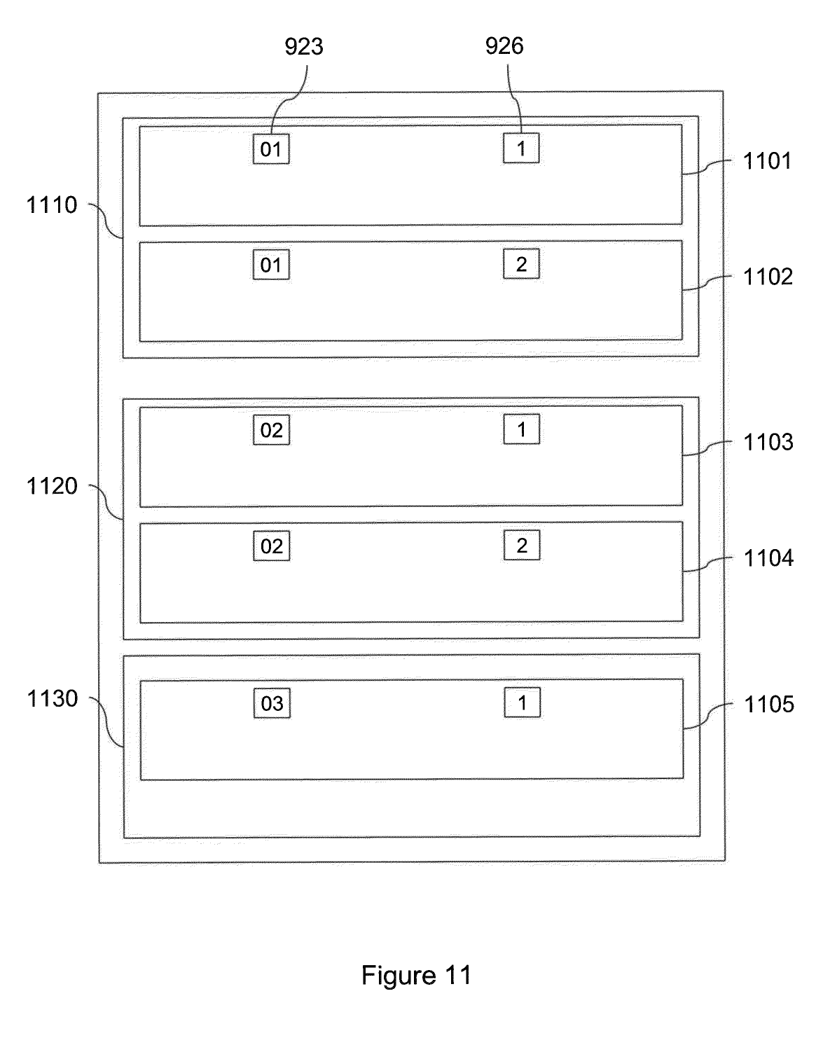

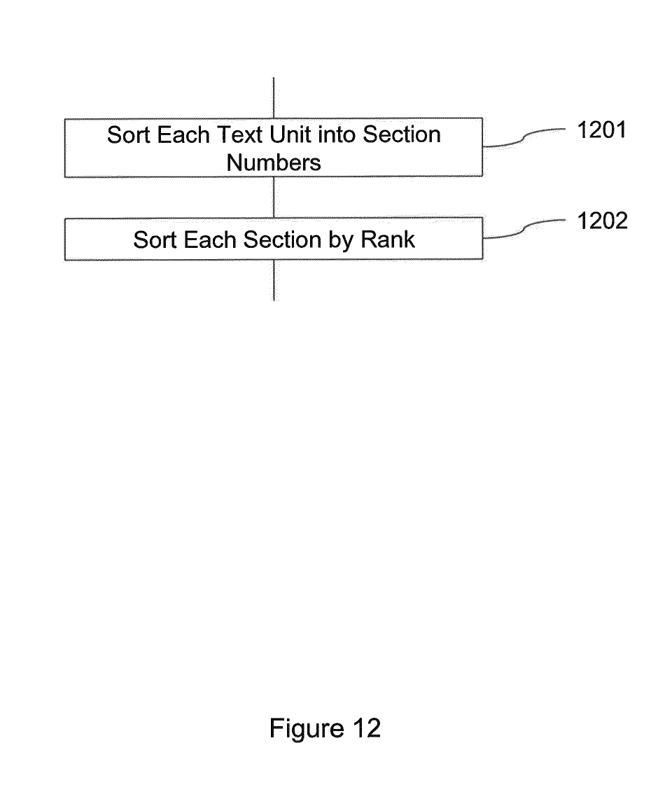

After the one or more text units are selected from the plurality of text units and the one or more text units are passed in to sets, positioning and application of rules need to be applied to each set. To sort the plurality of text units, part of the stored program code in the machine readable storage 102 executes instructions to sort one or more text units in each set. FIG. 11 illustrates a simple non-limiting example of a set of text units sorted according to the flow chart in FIG. 12, and where FIG. 12 is a flow chart that sets out the steps in sorting the text units. In this simple non-limiting example the 5 text units 1001, 1002, 1003, 1004, and 1005 are sorted according to their value in the indicator of the Section Cell or Contractual Cell 923. That is, the set organizes the text units 1001, 1002, 1003, 1004, and 1005 into ascending order first based on there Section Cell or Contractual Cell 923 (step 1201). In FIG. 11 there are three sections 1110, 1120, and 1130 and each section of the set corresponds to a section number 01, 02, and 03, respectively. Within each of the sections of the group of text units {1001, 1002}, {1003, 1004}, and {1005} are ordered according to the value of their rank in the Rank Cell 926 (step 1202). As can be seen in FIG. 11, within each group of text units {1001, 1002}, {1003, 1004}, and {1005} the text units are ordered according to their rank. Note that in FIG. 12 the steps of 1201 and 1202 may actually take place in a single step where each text units is added into a section and positioned in that section according to rank at the same time it is added into the section. Furthermore note that this sorting process may alternatively take place at step 1005 in FIG. 10 as part of the parsing operation and is not a separate step as illustrated above.

Next, part of the stored program code in the machine readable storage 102 is executed by the CPU 103 to execute instructions to evaluate rules associated with each of the text unit 900. In this specific and non-limiting example, each of the text units 900 has three rules associated with it. Rule 1: Dependency—a text unit can depend on another text unit and is only enabled with the option to be selected if another clause is selected. Rule 2: Incompatibility—a text unit is incompatible with another text unit and cannot be in the same set or groups of sets as another text unit. Rule 3: Complimentary—once a text unit is selected another complimentary text unit is required and is selected. Furthermore, for a group of text units one of the text units may be set as the default or pre-selected text unit. The instructions executed by the CPU 103 then take the set of pre-selected text units and rules the rules to determine any dependencies, incompatibilities, and complementariness.

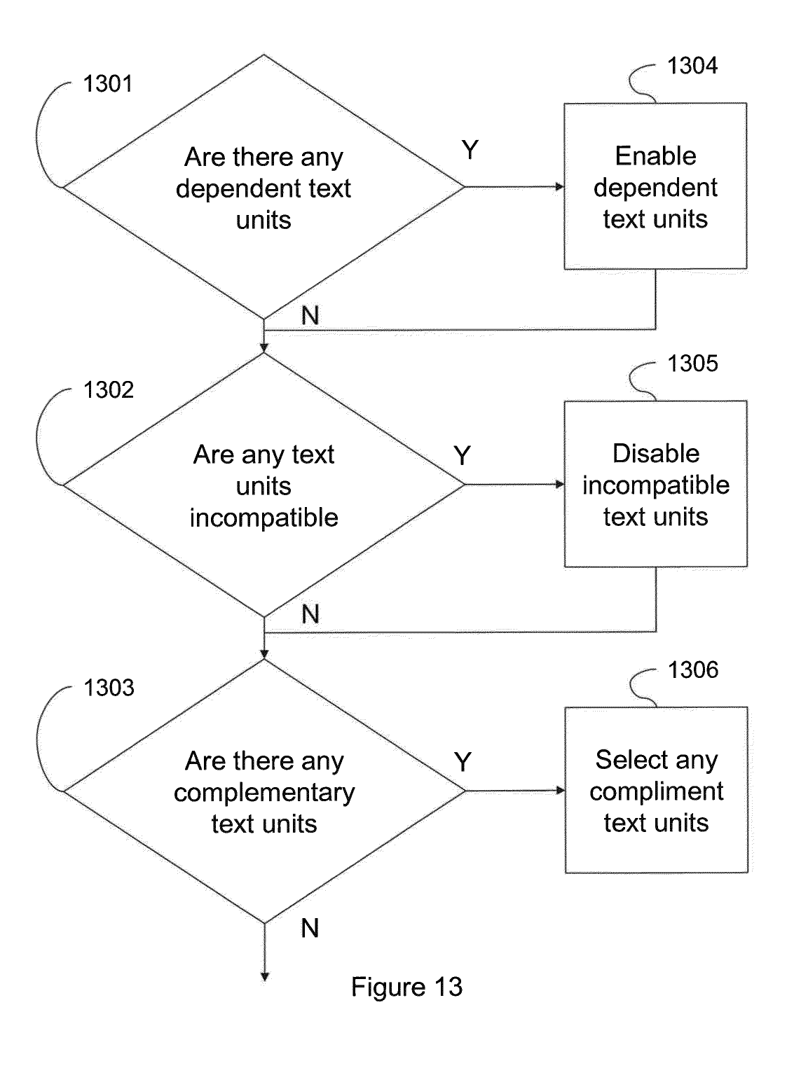

FIG. 13 is a flow chart illustrating a process of executing the three rules of dependency, incompatibility and complimentary. In non-limiting example, the instructions executed by the CPU 103 may be executed as follows using the process illustrated in FIG. 13. For each of pre-select text-units it is checked to determine whether any of the pre-selected text-units have one or more text unit that depend on it (step 1301), if so these one or more text units are then enabled (step 1304). Enabling of a text unit indicates that a user at later process will be able to select the text unit. Similarly, a disabled text unit indicates that a user will not be able to select the text unit. Then for each of the pre-select text-units it is checked to determine whether any of the pre-selected text-units are incompatible with other pre-selected text-units (step 1302), if so then the incompatible text units are disabled (step 1305). Then for each of the pre-select text-units it is checked to determine whether any of the pre-selected text-units have complimentary text units (step 1303), if so then the complimentary text units are then selected. The example given above may have to be repeated one or more times as at step 1303 more text units may be selected as part of the pre-selected text units. Alternatively each of the steps in FIG. 13 may be iterated through on a single text unit by single text unit basis. Another alternative is that the rules are pulled from each of the pre-selected text units and are generated into a list where the list is then processed.

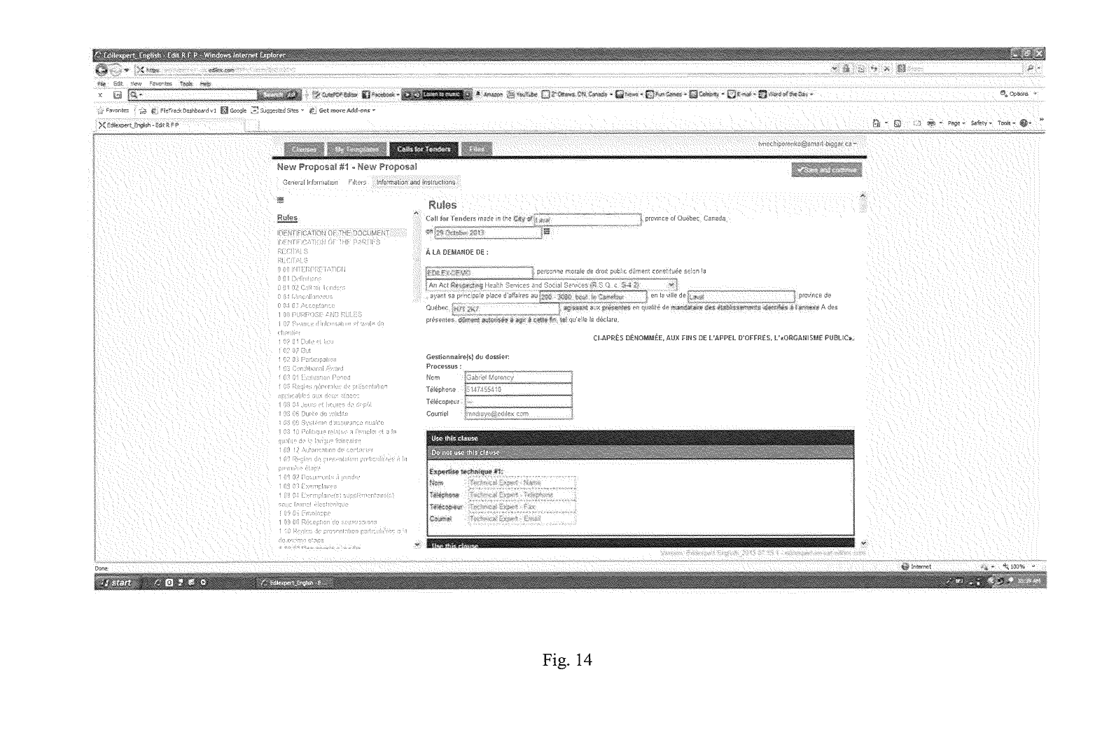

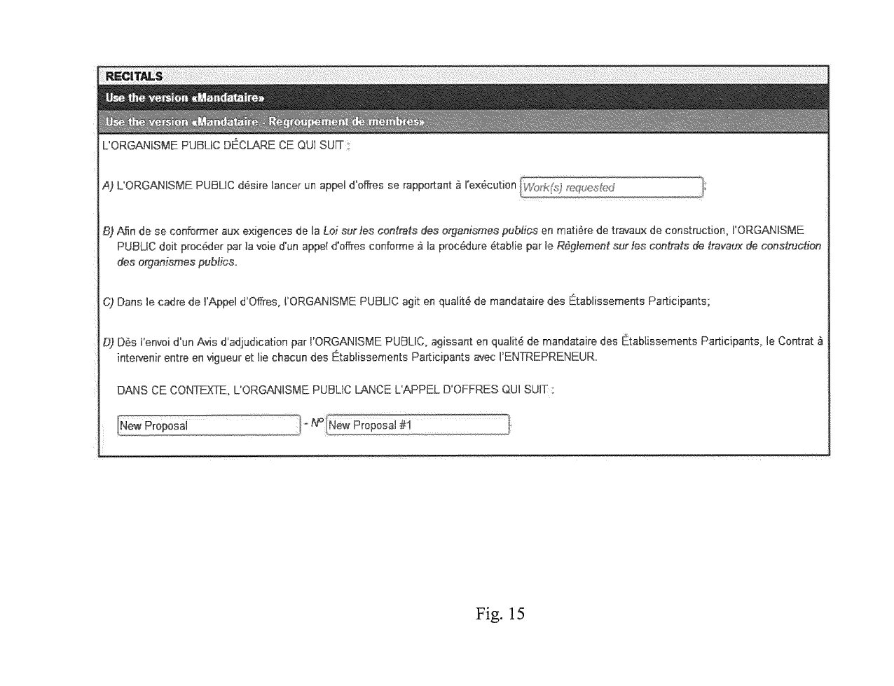

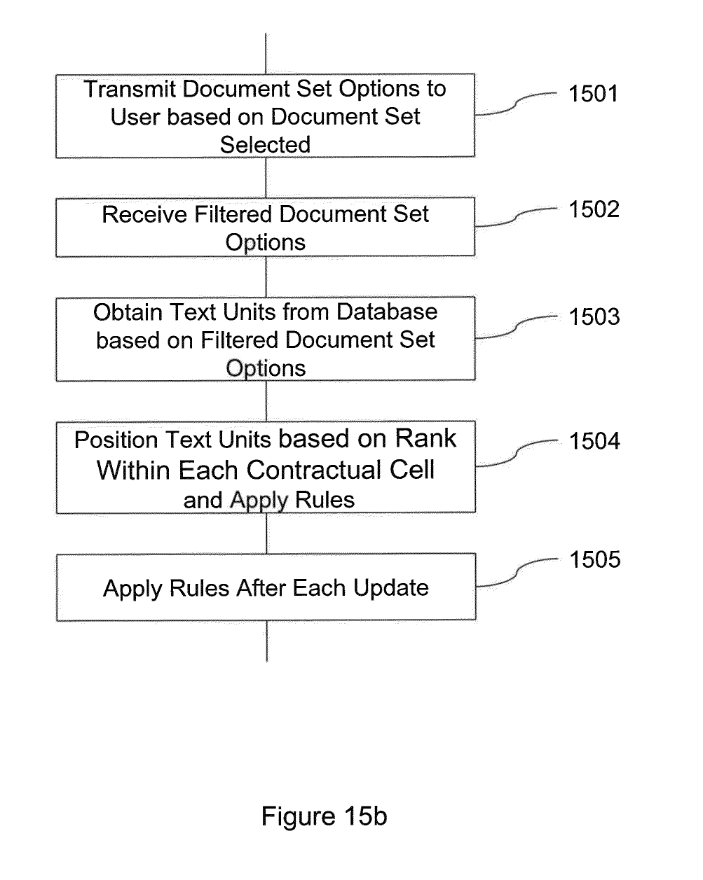

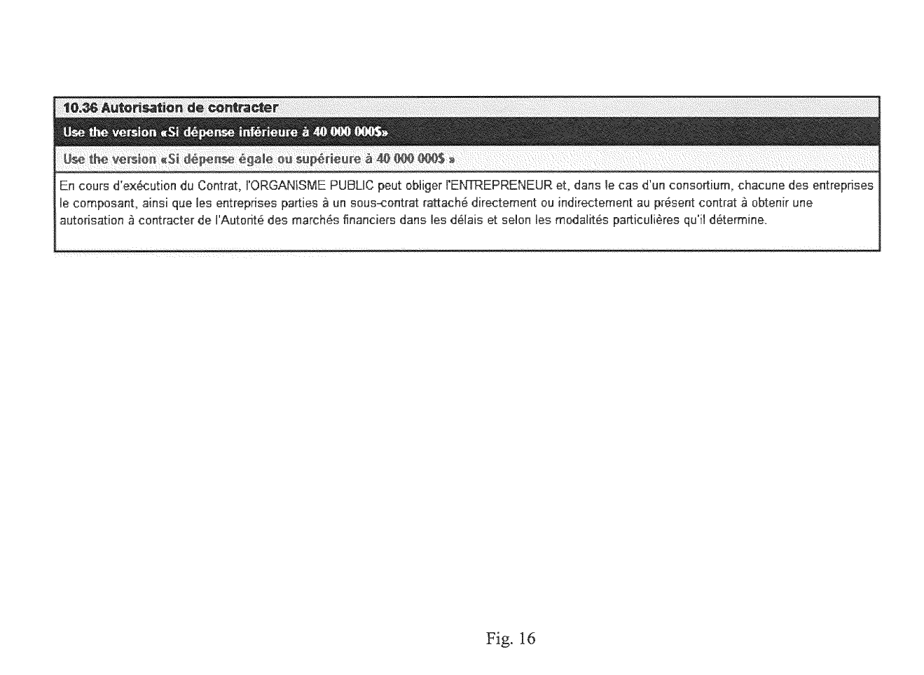

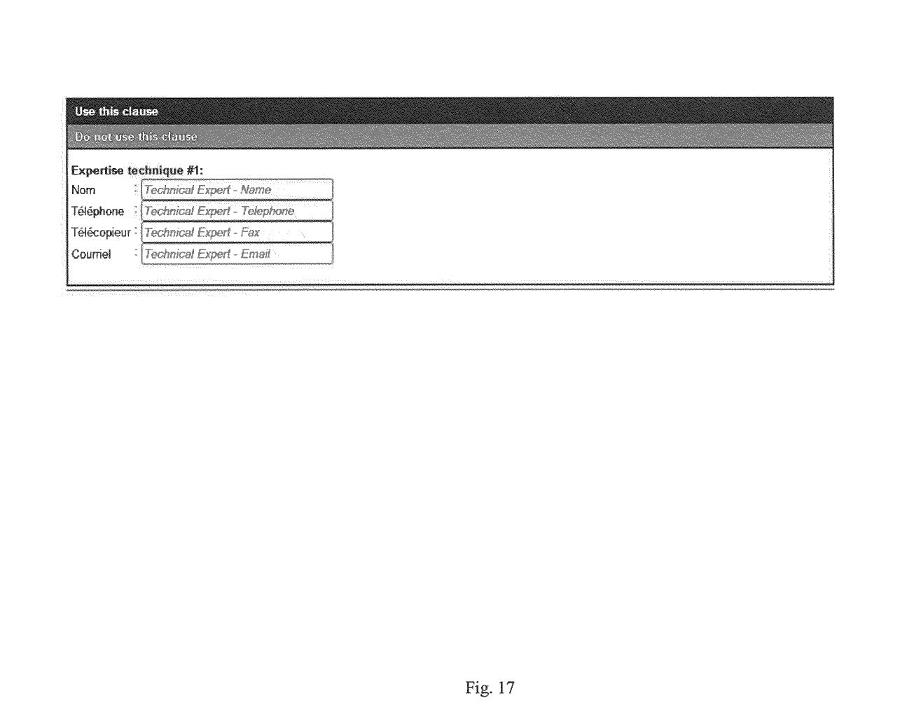

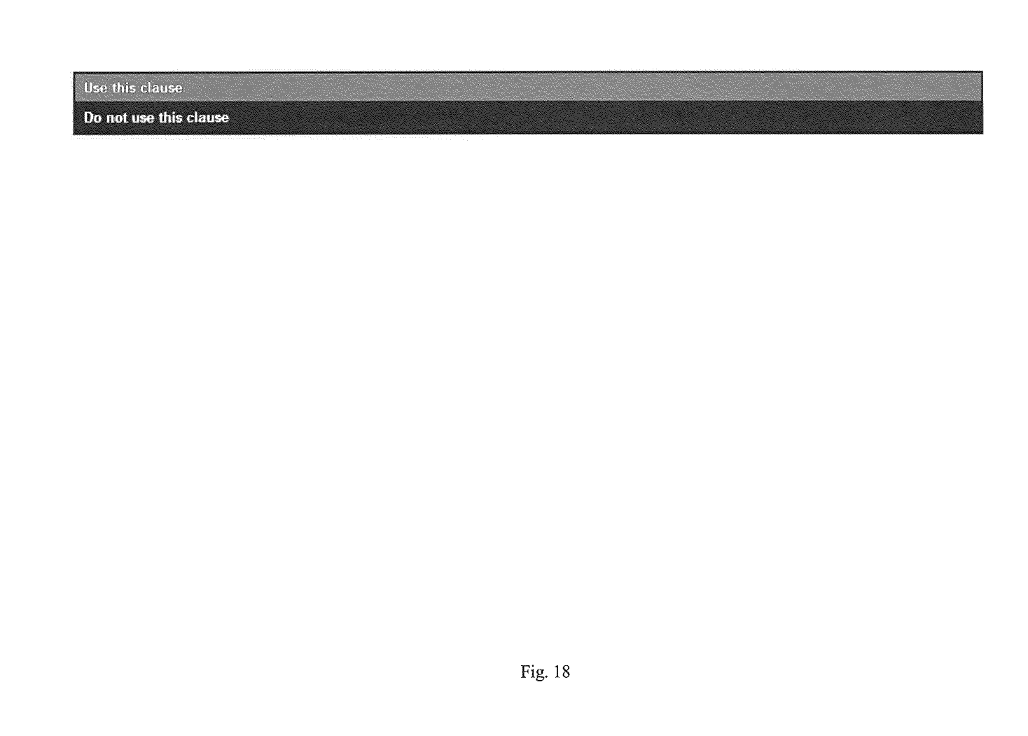

The text units after being processed and having the rules applied, the text units that require user interaction or selectability are communicated from the DGMS 100 through the web server to the user's 130 web browser and are visible in the user's 130 GUI in the information and instruction panel. FIG. 14 illustrates the user's 130 GUI using a web browser to view the information and instruction panel, where the text units are displayed as clauses and user interaction or selectability of these clauses may take place. The information and instruction panel shows a list of rules that require interaction by the user. Such interaction by the user may include the user inputting information into text boxes, selecting from dropdown menus or forms, etc. The user may also select whether a clauses should be included or not. For example, in FIG. 17 if the user clicks on “Do not use this clause” then this clause is unselected as shown in FIG. 18 and will not be put into the final generated documents in the document set. Other rules that may require interaction by the user are the section or toggling between two clauses, such as illustrated in FIG. 15 which shows a mandatory or essential clause but the user has the option to select one of the two mandatory clauses. When the user clicks or selects where a clause should be removed or whether to toggle between clauses this may triggers other clauses to be enabled or disabled. FIG. 16 shows clause in a red color which can not be selected by a user because it is disabled.

An interesting aspect to the above embodiment of the invention is that the enablement, disablement, selection and unselection of the text units can occur across multiple sets or across multiple documents. For example, if a user does an action that enables a text unit in one set, it may also enable a text unit in another set. Similarly, another example is if the user does an action that disables a text unit in one set this may disable a text unit in another set. Likewise another example is if the user does an action that enables a text unit in one set this may disable a text unit in another set, and vise versa. Furthermore for example, if a user selects a text unit in one set, it may also select a text unit in another set. Similarly, another example is if the user unselects a text unit in one set this may unselect a text unit in another set. Likewise another example is if the user selects a text unit in one set this may unselect a text unit in another set, and vise versa.

It may be possible to combine certain steps in FIGS. 10, 12, and 13 into a single step, re-arrange certain steps, or omit certain steps without taking away from the spirit of the invention. FIG. 15b illustrates flow chart of another embodiment of this invention and illustrates the steps of a process executed by the CPU 103 in response to the program code in machine readable storage 102. At step 1501 a process obtains document set options based on the user's document set selected which is then transmitted by the web server to the user 130 at CE 120. At step 1502 the next step in the process is receiving filtered document set options which may be understood as one or more indicators from a user. Then at step 1503 a process obtains text units from the data base based on the filtered document set options (one or more indicators). At step 1504 a process positions the text units based on one or more indicators such as rank and document section number and also applies rules to document set. At step 1505 a process continues to apply upon an event triggered by the user such as the selection of a text unit.

Once the user 130 is finished the interaction process, the user 130 can then generate the documents in the document set. This can be done by the user 130 clicking “Save and continue” in FIG. 14 which then generates the documents in the document set for the user 130. The user 130 can chose to export these documents to be downloaded to their CE 120 in formats such as Microsoft Word, Adobe PDF, etc. Alternatively to exporting the documents, the user 130 can view each of the documents in the web browser and make revisions to the documents. For instance, the user 130 may search for additional clause and add them to one or more documents in the document set. After the user 130 makes any final revisions to the documents, the user 130 may then export the documents at this time.

An advantageous aspect of the example in the current embodiment is that the DGMS generates three documents, however, the user 130 is not asked to review three documents worth of clauses. This is because a user is only shown a list in the Information and Instruction panel where user interaction may be required. This may be beneficial for users generating documents sets with many documents as they do not have to make similar or the same changes across multiple documents. In other words, in the current embodiment changes made in the Information and Instruction panel will produce changes across all documents in the document set. As such, an action done by the user such as selecting a text unit or clause may make one or more changes in multiple documents.

Interestingly, this invention shows a clause base or text unit based method and process for generating documents, instead of a template based process. However it is possible for a user to create a template from the generated documents sets that can be loaded as a starting point in the future to generate more documents and document sets.

The invention also allows the user to edit the text units depending on the user's privileges (previously discussed) or to even create new text units. An interesting aspect of the user's edit text units or new text units is that the use can save these text units as the pre-selected or default text units. Another interesting aspect of this invention is that the text units may be legal clauses used to generate legal documents.

In one embodiment the text units 900 may be update or revised which notifies the user of the update which is visible in the user's sidebar panel. The user can then choose to select the updated text to be a clause or not within the documents that he or she is creating.

In another embodiment of this invention, the DGMS is software that runs locally on a more stand-alone computers, servers, or any other generally portable or non-portable computing device and a user interacts with the DGMS through a GUI visible on a monitor or screen connected directly to the DGMS. In other words, the process explained above which is ran or executed on the DGMS 100 may be ran or executed fully or in part on the CE 120.

In another embodiment of this invention, the DGMS is software is software running on a server within an organization where multiple CE 130 connect as part of a LAN or WAN.

In another embodiment of this invention, the DGMS is software that does not generate document sets but only a single document using the same logic presented above.

The document generation and management system may simply be referred to as a document generations system, and vise versa throughout this document to refer to the same system.

A “text unit” is defined in this document to include the definition that defines a “content block”.

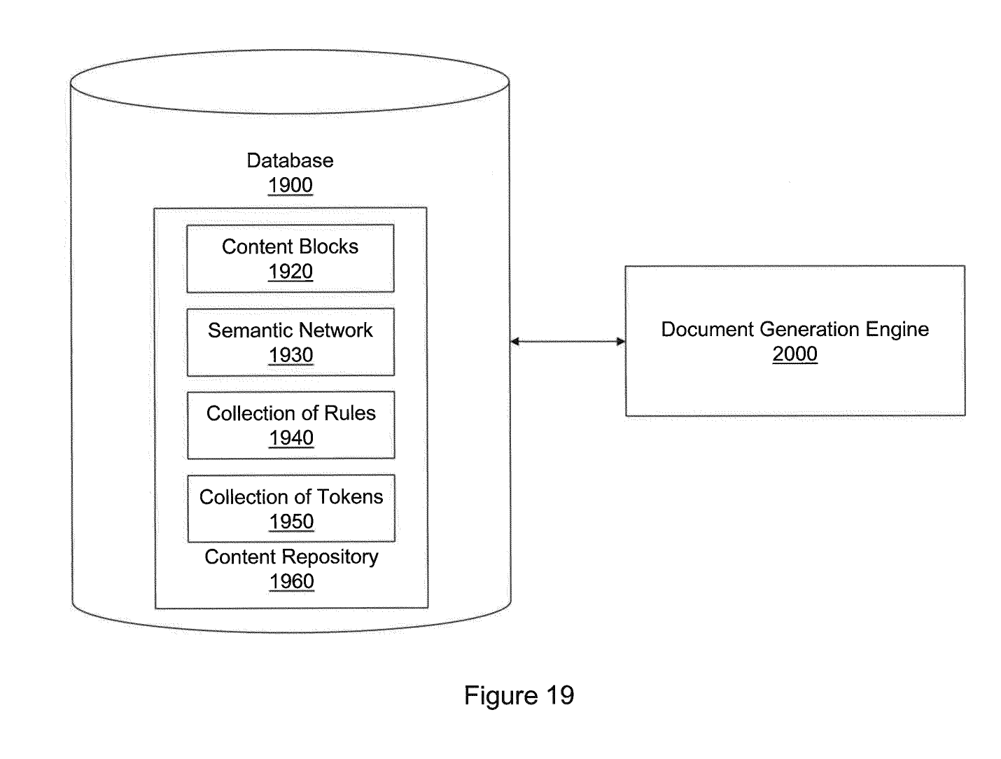

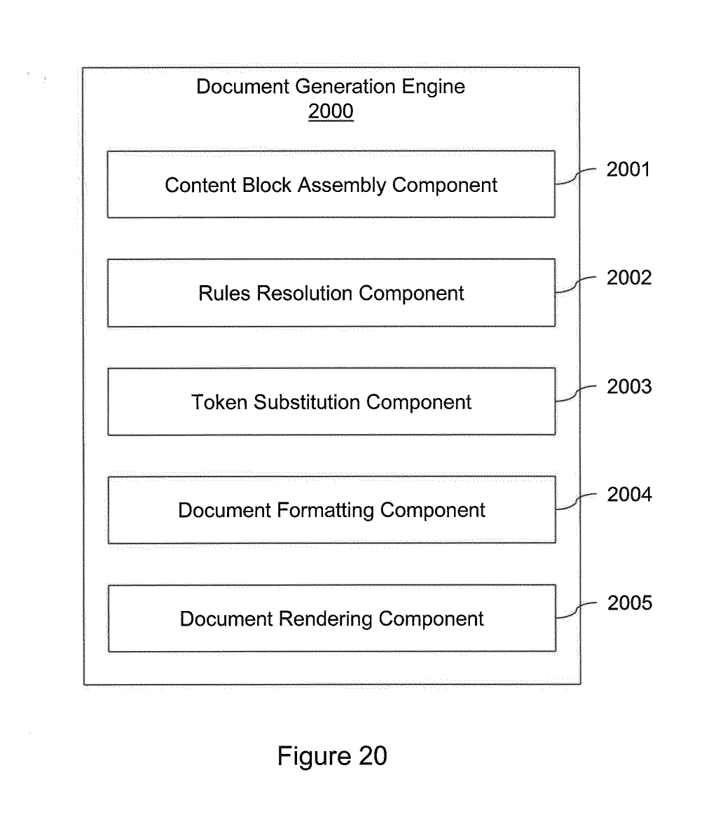

Another non-limiting example of implementation of the invention is presented below with reference to FIG. 19-20. FIG. 19 illustrates a document generation system for rapidly assembling a plurality of documents from a collection of content blocks. The document generation system generally comprises a document generation engine 2000 and a database 1900. The database 1900 contains a plurality of content repositories (not illustrated in FIG. 19). Each repository includes: (i) a semantic network; (ii) a collection of content blocks; (iii) a a set of rules that govern the relationships between content blocks; and (iv) a collection of tokens.

The content repository is illustrated in greater detail in FIG. 19. The content repository 1960 includes a semantic network 1930, consisting of a plurality of taxonomies, which can be dynamically added, modified, or removed. The content repository 1960 also includes a collection of a plurality of content blocks 1920, where a content block can be a phrase, a clause, or a block of text, and may include images or tables. A content block can also include metadata that describes the visual formatting and presentation of the content it contains. The content repository 1960 also includes the set of rules 1940 that define the relationships between content blocks, in particular whether certain content blocks can co-exist with other content block in the same document, among others. Furthermore, the content repository 1960 also includes the storage of collection of tokens 1960, which can be used to insert variable content (like names and addresses) into content blocks at run-time. Tokens are tied to individual content blocks. The association between tokens and content blocks can be one to one, where one token is associated with a particular content block, or one to many, where one token is associated with multiple content blocks. In the case of such one to many association, a change in the content of the token will reflect itself in multiple content blocks.

An application layer (not illustrated) includes a user management component, and a component to accept and respond to requests to render documents from a user or a users computing entity.

FIG. 20 illustrates document generation engine 2000 and its various components. It is to be understood that the components are software implemented. The document generation engine 2000 comprises a content block assembly component 2001 that will assemble document elements based on input parameters; a rules resolution component 2002 that applies and resolves the relationships between content blocks; a token substitution component 2003 that locates all variable tokens in the content blocks and substitutes the required values; a document formatting component 2004 that orders the content blocks assembled by the application layer, and applies a template and formatting rules to create a meta-document that includes the document content and formatting information; a document rendering component 2005 that renders the meta-document in one of several popular file formats, including Microsoft Word, Adobe PDF, or HTML documents.

The semantic network 1930 maintains a semantic network of taxonomies in which the relationship between content is organized. In the context of creating legal documents, a taxonomy is a hierarchy of classifications so that complex documents, including legal documents may include a hierarchy relating to the set of sub-documents making up the document.

At the top level of the semantic network legal documents are associated with sub-documents which can be defined individually as units or further sub-divided into sub-document sections. In turn, content blocks are associated with respective sub-document sections.

Inside each section of a sub-document, content blocks are organized with a priority, which is used to order content blocks within a section. Each document is also associated with a template, which specifies how text and other elements are visually formatted within the document.

Each content block may further contain child-elements, called sub-clauses. Sub clauses can be flagged as “optional”, so a user of the system can determine at run-time whether or not these child elements will appear in the final output document.

The relationship between documents, sub-documents and individual content blocks can be expressed as a tree structure with branches and leaf nodes.

Content blocks 1920 can be dependent, associative or exclusive. The set of rules 1940 determines those relationships. Content blocks are dependent (if content block A appears, then content block B must also appear); associative (if content blocks A and B appear, then content block C will also appear); or exclusive (if content block A appears, then content block B must not appear).

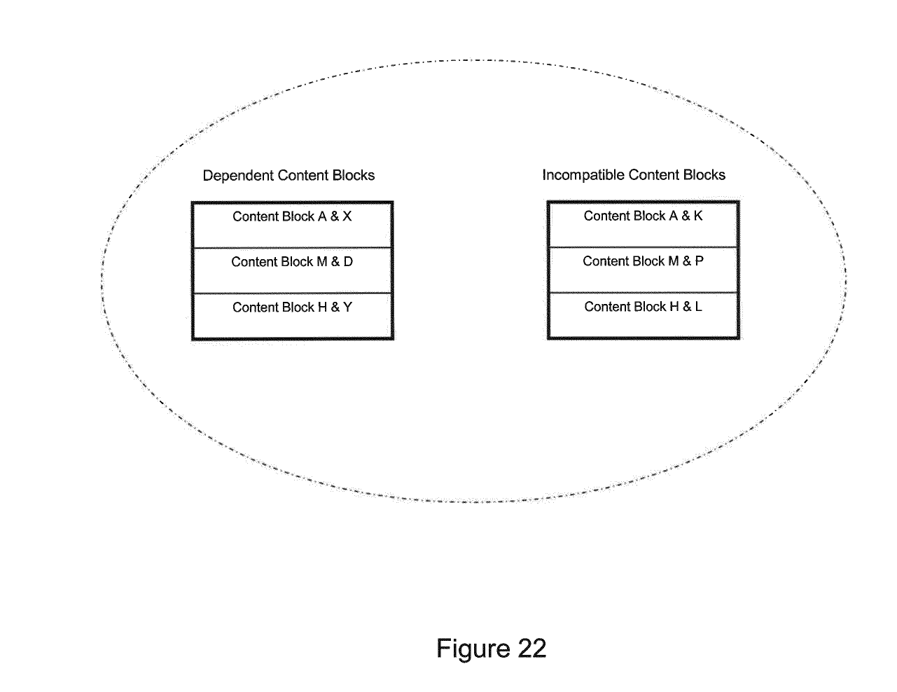

As shown in FIG. 22, content block X depends upon content block A. Accordingly, as the user selects content block A, content block X is also automatically selected by the system logic. Conversely, as content block A is deselected, the dependent content block X is also deselected by the system logic. Note that the dependency relationship is not strictly one to one as it may be one to many, in other words one content block may have multiple content blocks depending from it. Exclusive content blocks are content blocks which cannot co-exist in the same document. In the example shown in FIG. 22, A and K are incompatible content blocks, as are M and P and H and L. This means that when the user selects a content block, the logic will determine if any incompatible content blocks are present and remove the incompatible content blocks.

Because the relationships defined by rules can become complex, the rules engine or rules resolution component 2002 will resolve rules iteratively, until all of the relationships are satisfied.

The system also includes a collection of tokens. Content blocks can contain references to tokens, which are replaced with user-supplied parameters at run-time. For example, when a user is asked to specify information relating to a content block such as names of the contracting parties, their address, etc., this information is stored in the database as illustrated in the block diagram of FIG. 19 as the Collection of Token 1950 block.

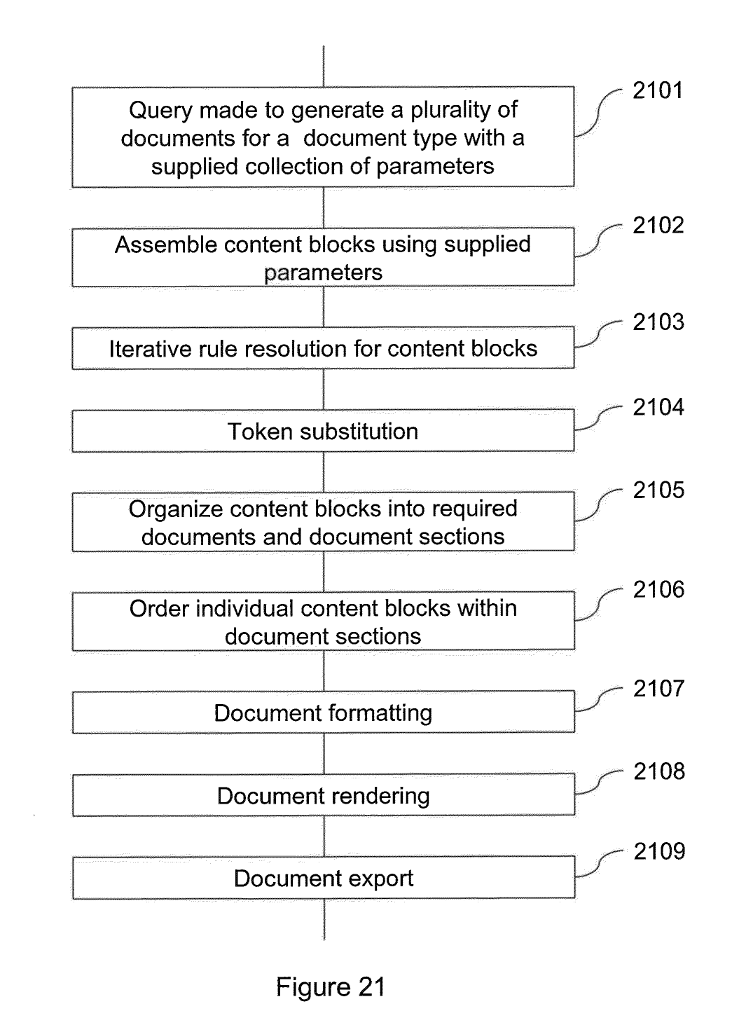

Referring now to FIG. 21, the which illustrates the process or method executed by the document generation system. At step 2101 a user or a software entity can query the application layer of the system to generate a plurality of documents. Then at step 2102, the user or software entity must request a document type, and supply a collection of parameters in order to define the document and its components, in particular the sub-documents required. If the request fails to supply all of the necessary parameters, the system will prompt them for missing parameters. Next at step 2103, the content block assembly component 2001 will use the supplied parameters to select all of the content blocks 2001 that are associated with the taxonomy leaves or branches supplied in the parameters.

Once all of the content blocks have been assembled, at step 2103 the rules resolution component will apply the rules that are associated with each content block, and iteratively resolve them until there are no ruled conflicts between content blocks.

At step 2103 the token substitution component will parse all of the selected content blocks, and substitute the required values for the tokens (step 2104). The document formatting component 2004 will first organize the content blocks into the required documents and document sections (step 2105).

The document formatting component 2004 will then order the individual content blocks within the document sections (step 2106). At the document formatting component 2004 will then create a meta-document for each requested document. The component will first apply formatting rules associated with the template for each document and then apply any formatting metadata contained within the content blocks themselves (step 2107).

Finally, at step 2108 the document rendering component will then render the meta-document for each requested document into one of several popular file formats, including Microsoft Word, Adobe PDF, or HTML documents. The completed documents will either be returned to the user or software entity as a binary file or a formatted HTML text file (Step 2109).

Note that the application of the set of rules that govern the relationship between the content blocks is invoked in response to changes that the user makes to the document generated by the system. If a content block is removed the rules will automatically remove content blocks that are identified by the set of rules as being dependent and also remove the content blocks defined as associative.

In a different example, if a content block is added by the user to the document, then the set of rules operate to remove any content blocks that are defined as being exclusive.

The rules of dependency, associativity and exclusivity provide a logic framework that remains simple, yet it is sufficiently flexible to generate on the basis of individual content blocks a documents that convey complex legal concepts.

Any feature of any embodiment discussed herein may be combined with any feature of any other embodiment discussed herein in some examples of implementation.

Although various embodiments and examples have been presented, this was for the purpose of describing, but not limiting, the invention. Various modifications and enhancements will become apparent to those of ordinary skill in the art and are within the scope of the invention.

1. (canceled)

2. (canceled)

3. (canceled)

4. A computer system for dynamically generating one or more documents, by ordering a plurality of content blocks in different ways to create the one or more documents, the computer system comprising:
a. a non-transitory computer readable medium containing a plurality of databases, the plurality of database including:
i. a content block database, containing the plurality of content blocks, each of said content blocks being associated with a plurality of metadata entities;
ii. a metadata filter database, containing a plurality of hierarchies of metadata entities;
iii. a set of rules in a table, said table containing a plurality of metadata structures defining relationships between content blocks, said relationships being defined as dependencies, associations, and incompatibilities;
iv. a document definition database, containing a plurality of metadata entities which define and describe a plurality of arbitrary document structures;
v. a document template database, containing a plurality of metadata entities describing document formats for presentation;
b. a processor executing machine readable instructions, said instructions including:
i. causing a document generation service, in response to input by a user, to create a meta-document which describes the content and structure of a document;
ii. causing a rules engine to querying the set of rules to identify any rules which may be applied to content selected for the meta-document and which resolves said set of rules by adding or removing content blocks, depending on the relationships defined in these rules;
iii. causing a document rendering service, in response to input by the user, to render the meta-document as a final document in the file format of the user's choice;
iv. causing a user interface associated with a computing device of the user to display a set of tools and user interface controls which allow the user to add, remove, or modify content blocks, to add, remove, or modify taxonomy metadata and document definitions, or to compose and generate new documents;
v. causing a management console to be displayed on the user interface allowing an administrator of the computer system to modify user rights, add or remove users, or to make systemic changes to taxonomy entities, document definitions, or to document templates.

5. The computer system of claim 4, wherein the arbitrary document structures are stored in the document definition database as pointers to content blocks, and corresponding metadata entities that describe in what order said content blocks should appear in the document; said document definition database also including a plurality of metadata entities describing other document elements, including headings, page breaks, and tokens for dynamic variable content which is supplied at run-time.

6. The computer system of claim 4, wherein the meta-document comprises a plurality of pointers to content blocks, and to corresponding metadata entities contained in a document definition database, describing how said content blocks are to be ordered and linked.

7. The computer system of claim 4, wherein said instructions further include the document generation service querying the content block database to assemble all of the content blocks which correspond to the metadata entity selections made by the user; and assembling said content blocks according to the selected document definition; and replaces any tokens for dynamic variable content with final values, wherein the final values are supplied by the user or are supplied from data provided by an external database or computer program.

8. The computer system of claim 4, wherein said instructions further include the document rendering service querying the document template database to obtain the metadata necessary to style the presentation and appearance of the final document after the manner of a template selected by the user.

9. A method for dynamically composing and generating documents, by breaking down text and multi-media content into small, independent content blocks and then re-ordering and recompiling said content blocks in different ways to create a plurality of different documents on demand, according to the specifications of a user, said method including:
i. the user defining a meta-document, said meta-document comprising a plurality of pointers to content blocks and corresponding meta data entities describing how the content blocks are to be ordered and linked;
ii. the user selecting from a plurality of document definitions and further describing a desired document by making selections from a plurality of metadata filters.

10. The method of claim 9, wherein arbitrary content from a variety of text, formatted documents, and other multimedia content is broken down into small, self-contained, independent blocks after a manner which allows them to be re-used with a high degree of orthogonality, allowing said content blocks to be recombined and re-ordered in a plurality of different ways.

11. The method of claim 9, wherein a user is presented with a user interface, in a web browser resident on the user's computer, said user interface allowing the user to add, remove, or modify elements of a plurality of metadata filter entities which are persisted in non-volatile storage in the metadata filter database.

12. The method of claim 9, wherein the user is presented with a user interface allowing the user to add, remove, or modify content blocks, which are persisted in non-volatile storage in a content block database.

13. The method of claim 9, wherein the user is presented with a user interface which allows the user to add, remove, or modify document definitions, which describe the structure of an arbitrary document without explicitly describing the content of the document, said document definitions being persisted in non-volatile storage in a document definition database.

14. The method of claim 11, wherein the user interface allows the user to associate content blocks with a plurality of document definitions or metadata filter entities, said associations comprising metadata entities which are persisted in non-volatile storage in a content block database.

15. The method of claim 9, wherein a user is presented with a user interface which allows the user to define rules, said rules comprising relationships of dependency, incompatibility, or association between pairs of content blocks, said rules being persisted as metadata entities in non-volatile storage in a set of rules table of a database.

16. The method of claim 9, wherein a user is presented with a user interface which allows the user to invoke a document generation service to specify and generate a document.

17. The method of claim 16, wherein the user is presented with tools and user interface controls which allow the user to make a plurality of arbitrary selections of one or more document definitions and a plurality of taxonomy metadata entities in order to specify the content of the desired document.

18. The method of claim 17, wherein the user is presented with an opportunity to supply values to replace tokens for variable content in a final document.

19. The method of claim 9, wherein the method further includes a document generation service querying a document definition database and a metadata filter database in order to discover all of the content blocks which are associated with the user's selections, and querying the content block database to extract the content of each of the content blocks which have been identified.

20. The method of claim 19, wherein the document generation service invokes a rules engine to resolve any relationships of dependency, association, or incompatibility that exist between the content blocks which have been selected to form the basis of a meta-document.

21. The method of claim 20, wherein the rules engine iteratively adds and removes content blocks based on the relationships that have been defined between them, until all of the relationships defined for the content have been resolved.

22. The method of claim 21, wherein if the rules engine cannot resolve all of the relationships between content blocks, it will prompt the user to make a selection via the user interface to select one or more of a plurality of content blocks that cannot automatically be selected by the system.

23. The method of claim 11, wherein the user may identify a content block as optional.

24. The method of claim 11, wherein the user may identify a plurality of alternative forms of a content block, and associate each alternative form with different taxonomy metadata or rules.

25. The method of claim 16, wherein a document generation service presents the user with a draft version of the completed meta-document for review in the user interface.

26. The method of claim 25, wherein the user is presented with user interface tools which allowing the user to toggle the visibility of content blocks which have been marked as optional on or off.

27. The method of claim 25, wherein the user is presented with user interface tools which allowing the user to select one alternate form from a plurality of alternate forms of a content block where more than one alternate version of the content block is compatible with the metadata filter entities specified by the user for the desired document.

28. The method of claim 25, wherein the user is presented with tools and user interface controls allowing the user to make manual adjustments to the content blocks which have been identified by the document generation service.

29. The method of claim 9, wherein the user is presented with a user interface which allows the user to invoke a document rendering service to output a final document.

30. The method of claim 29, wherein the user is presented with user interface tools which allow the user to select one of a plurality of document templates and one or more of a plurality of file formats to which the final meta-document is rendered.

31. The method of claim 9, wherein a document rendering service queries a document template database to retrieve the presentation metadata associated with a document template selected by the user, and generates a completed document file for download by the user.
